(19) United States
(12) Patent Application Publication
(10) Pub. No.: US 2026/0238464 A1
(43) Pub. Date: Aug. 13, 2026

(54) METHOD AND SYSTEM FOR QUANTUM COMPUTATIONS WITH RESOURCE MANAGEMENT AND SECURE ENCRYPTION

(71) Applicant: Richard D'souza, Langley (CA)

(72) Inventor: Richard D'souza, Langley (CA)

(21) Appl. No.: 19/001,965

(22) Filed: Dec. 26, 2024

(51) Int. Cl. H04L 9/08; H04L 9/00

(52) U.S. Cl. CPC H04L 9/0852; H04L 9/0819; H04L 9/50

(57) ABSTRACT

The present disclosure relates to a method for performing one or more quantum computations. The method comprises initializing, by one or more quantum processing units (QPUs), qubits for the quantum computations. The quantum computations are received by an artificial intelligence module, which utilizes machine learning techniques to analyse the received quantum computations. Based on analysis, allocation and optimization of quantum resources is dynamically managed for the selection of QPUs. Securely logging, by a blockchain module, the quantum computations and decision of artificial intelligence module into an immutable blockchain ledger. Additionally, by using a quantum encryption module, the communications between the quantum processing units, the artificial intelligence module, and the blockchain module, are encrypted.

### FIELD OF THE INVENTION

The present disclosure generally relates to quantum computing. Further, the present disclosure particularly relates to methods for performing quantum computations with resource management, secure logging, and communication encryption.

### BACKGROUND

The background description includes information that may be useful in understanding the present invention. It is not an admission that any of the information provided herein is prior art or relevant to the presently claimed invention, or that any publication specifically or implicitly referenced is prior art.

Quantum computing is an advanced computational technique to address computational tasks that are not manageable by the classical computing systems. There are several applications for quantum computing, such as artificial intelligence, optimization, medicine development, and cryptography.

Among others, major issue in quantum computing involves dynamic resource management, because the allocation and optimization of quantum resources (such as qubits, quantum gates, and error the correction codes) are essential for effective operation of the quantum computing systems. Traditional resource allocation methods cannot change (because of being static) to meet the real-time needs of intricate quantum computations. Especially in systems that manage several tasks or need real-time modifications, such inability may result in inefficiencies, resource bottlenecks, and inadequate utilization of computer resources. Although techniques like machine learning have been identified to overcome said obstacles, scalability and processing overhead limit their incorporation into quantum systems.

Additionally, conventional centralized logging systems are susceptible to single points of failure, illegal access, and manipulation. Such problems impair accountability and traceability while compromising the accuracy of recorded data. A possible remedy is provided by decentralized logging systems, like cryptographic ledgers, which produce safe and unchangeable recordings of computing operations. However, implementing the decentralized logging systems in quantum computing environments is complex and resource-intensive, requiring solutions to meet the high-performance demands of the quantum systems.

Furthermore, data security is also a concern in quantum computing because of sensitivity of the data being processed. The risks of security breaching posed by quantum technologies are not efficiently addressed by the conventional cryptography techniques. Improvised security measures are offered by quantum cryptography techniques (like entanglement-based encryption and quantum key distribution), wherein the quantum cryptography techniques make use of quantum characteristics to enable secure communication and identify intrusion. However, implementing quantum cryptographic solutions in quantum computing systems presents challenges related to scalability, resource overhead, and maintaining communication integrity in the dynamic environments.

Therefore, there exists an urgent need for solutions that address the limitations associated with qubit initialization, dynamic resource management, reliable logging of computational activities, and secure communication in quantum computing systems.

### SUMMARY

The following presents a simplified summary of various aspects of this disclosure in order to provide a basic understanding of such aspects. This summary is not an extensive overview of all contemplated aspects and is intended to neither identify key or critical elements nor delineate the scope of such aspects. Its purpose is to present some concepts of this disclosure in a simplified form as a prelude to the more detailed description that is presented later.

The following paragraphs provide additional support for the claims of the subject application.

The present disclosure relates to a method for performing the one or more quantum computations, the method comprising initializing, by the one or more quantum processing units (QPUs), the qubits for the one or more quantum computations; receiving, the one or more quantum computations by an artificial intelligence (AI) module, wherein the AI module utilizes one or more machine learning techniques to analyze the received one or more quantum computations to dynamically manage allocation and optimization of the one or more quantum resources for selection of one or more QPUs; logging securely, by a blockchain module which when executed by the one or more selected QPUs, the one or more quantum computations and decision of the AI module, into an immutable blockchain ledger; and encrypting, by a quantum encryption module (QEM) which when executed by the one or more selected QPUs, the communications between the QPU, the AI module and the blockchain module.

In an embodiment, the quantum resources comprising a qubit allocation, a quantum technique selection and an error correction.

In an embodiment, the QPUs execute the error correction instructions provided by the AI module, wherein the error correction instructions being dynamically updated based on analysis of the one or more quantum computations.

In an embodiment, the AI module utilizes one or more machine learning techniques to predict the optimal quantum gate sequences and the dynamic optimization rules for the QPUs.

In an embodiment, the quantum encryption employs quantum entanglement and superposition for encryption and decryption.

In an embodiment, each QPU is associated with a sequence of quantum gates being controlled by the AI module to perform the one or more quantum computations.

In an embodiment, the dynamic reallocation of the quantum resources by the AI module comprises redistribution of the qubit states of the QPUs, based on the one or more quantum computations.

In an embodiment, the blockchain module records the error correction adjustments and the quantum technique selection performed by the AI module, onto the immutable blockchain ledger.

In an embodiment, the AI module monitors an error correction performance of each QPU to adjust the allocation of quantum resources.

In an embodiment, the blockchain module logs metadata selected from a utilized quantum technique, a qubit allocation scheme, and an execution parameter associated with the one or more quantum computations.

In an embodiment, the AI module optimizes entanglement distribution across the QPUs to secure the one or more quantum computations outcomes to minimize a computational overhead and maintain QKD.

In an embodiment, the AI module categorizes received one or more quantum computations and allocates the qubits across the plurality of QPUs based on the categorization.

In an embodiment, the AI module is trained by the reinforcement learning models utilizing historical and real-time data derived from performance metrics of the one or more QPUs to improve accuracy and efficiency in the allocation and optimization of the one or more quantum resources.

In an embodiment, the encryption of communications between the QPU, the AI module, and the blockchain module utilizes lattice-based cryptography for quantum attack resistance and quantum-resistant hash functions for ensuring data integrity.

In an embodiment, the method further comprising utilizing a continuous-variable quantum key distribution (CV-QKD) to secure communications between QPUs and the QEM.

In an embodiment, the method further comprising applying multiplexing techniques to support secure quantum key exchanges among the one or more QPUs and the blockchain module.

In an embodiment, the one or more QPUs incorporate quantum annealing to enable rapid reconfiguration of the qubits upon detection of faults during the initialization or execution of the one or more quantum computations.

In an embodiment, the initialization of the qubits by the one or more quantum processing units further comprises generating a quantum digital signature associated with each qubit; verifying, by the quantum encryption module, the authenticity of the generated quantum digital signature using quantum-based protocols; and storing the quantum digital signature within the immutable blockchain ledger by the blockchain module.

The present disclosure further comprises a quantum computing system, the system comprising the one or more quantum processing units (QPUs) initializes the qubits for one or more quantum computations, each QPU is coupled to a non-transitory storage device, wherein the non-transitory storage device comprises an artificial intelligence (AI) module, a blockchain module and a quantum encryption module (QEM); the AI module receives the one or more quantum computations; and utilizes one or more machine learning techniques to analyze the received one or more quantum computations to dynamically manage allocation and optimization of the one or more quantum resources for the one or more QPUs selection; the blockchain module, which when executed by the one or more selected QPUs, securely logs the one or more quantum computations and decision of the AI module, into an immutable blockchain ledger; and the quantum encryption module (QEM), which when executed by the one or more selected QPUs, utilizes quantum key distribution (QKD) to generate the quantum keys to encrypt the communications between the QPU, the AI module and the blockchain module.

In an embodiment, the quantum resources comprising a qubit allocation, a quantum technique selection and an error correction.

In an embodiment, the AI module utilizes one or more machine learning techniques to predict the optimal quantum gate sequences and the dynamic optimization rules for the QPUs.

In an embodiment, the quantum encryption employs quantum entanglement and superposition for encryption and decryption.

In an embodiment, the dynamic reallocation of the quantum resources by the AI module comprises redistribution of the qubit states of the QPUs, based on the one or more quantum computations.

In an embodiment, the blockchain module records the error correction adjustments and the quantum technique selection performed by the AI module, onto the immutable blockchain ledger.

In an embodiment, the AI module monitors an error correction performance of each QPU to adjust the allocation of quantum resources.

The present disclosure further comprises a non-transitory computer-readable storage medium embodying a set of instructions, which when executed by one or more quantum processing units (QPUs), causes the one or more QPUs to perform a method comprising initializing, the qubits for the one or more quantum computations; receiving, the one or more quantum computations by an artificial intelligence (AI) module, wherein the AI module utilizes one or more machine learning techniques to analyze the received one or more quantum computations to dynamically manage allocation and optimization of the one or more quantum resources for selection of one or more QPUs; utilizing the one or more selected QPUs for logging securely, the one or more quantum computations and decision of the AI module, into an immutable blockchain ledger; and encrypting, the communications between the QPU, the AI module and the blockchain module.

### BRIEF DESCRIPTION OF THE DRAWINGS

The features and advantages of the present disclosure would be more clearly understood from the following description taken in conjunction with the accompanying drawings in which:

FIG. 1 illustrates a method for performing the one or more quantum computations, in accordance with the embodiments of the present disclosure.

FIG. 2 illustrates a quantum computing system, in accordance with the embodiments of the present disclosure.

FIG. 3 illustrates a sequence diagram for a quantum computing system, depicting the interaction between components in accordance with the embodiments of the present disclosure.

FIG. 4 illustrates representation for performing quantum computation, in accordance with the embodiments of the present disclosure.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to claim those skilled in the art to practice the invention. Other embodiments may be utilized, and structural, logical, and electrical changes may be made without departing from the scope of the present invention. The following detailed description is, therefore, not to be taken in a limiting sense, and the scope of the present invention is defined only by the appended claims and equivalents thereof.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Pursuant to the “Detailed Description” section herein, whenever an element is explicitly associated with a specific numeral for the first time, such association shall be deemed consistent and applicable throughout the entirety of the “Detailed Description” section, unless otherwise expressly stated or contradicted by the context.

As used herein, the term “quantum processing unit” (QPU) refers to a device that performs quantum computations by utilizing qubits (the fundamental units of quantum information). To solve the computing tasks, the QPU utilizes quantum states that are selected from entanglement and superposition. Entanglement couples the states of one qubit to another, on the other hand, superposition describes a state in which the qubits can represent multiple values (such as 0 and 1). QPUs typically comprise the quantum circuits (comprising quantum gates and error correction mechanisms), enabling the manipulation of qubit states for computational purposes.

As used herein, the term “qubit” refers to a fundamental unit of quantum information used in a quantum processing. A qubit may be configured in a state defined by quantum mechanics such as 0, 1, or a superposition of both, enabling quantum computations. Qubits may also be configured in entangled states, where the state of one qubit is interdependent on the state of another qubit, enabling enhanced computational capabilities.

As used herein, the term “artificial intelligence” (AI) refers to a computational protocol that utilizes machine learning, statistical models, and data analysis techniques to process and analyse information. AI is utilized to analyse task parameters and enable dynamic allocation of the quantum resources. Such AI utilizes machine learning techniques, comprising supervised learning for predicting qubit requirements, unsupervised learning for clustering computational tasks, and reinforcement learning for optimizing the execution of quantum computations.

As used herein, the term “blockchain” refers to a distributed and unalterable ledger that securely records data in sequentially linked blocks using the cryptographic techniques. Blockchain is arranged to log quantum computations, resource allocation decisions, and error correction strategies executed by QPUs. Each block within the blockchain comprise metadata, such as the task details, the timestamps, and the cryptographic hashes, which link each block to the previous one, forming a chain. Blockchain applies encryption techniques (such as SHA-256, etc.) to secure the logged data, thereby preventing unauthorized access.

As used herein, the term “quantum encryption” refers to a mechanism that secures data using principles of quantum mechanics (comprising quantum key distribution, superposition, and entanglement). Quantum encryption uses quantum key distribution (QKD) to generate encryption keys based on the properties of the quantum states. Any attempt to intrude the quantum key alters the state, making unauthorized access detectable. Superposition allows qubits to be configured in multiple encryption states, increasing the complexity of cryptographic keys, while entanglement establishes secure correlations between the qubits for data exchange.

As used herein, the term “error correction” refers to the process of detecting and correcting errors that occur during quantum computations because of the environmental disturbances, decoherence, or gate imperfections. Error correction is performed using quantum error correction codes (such as surface codes or concatenated codes), which encode the logical qubits into the multiple physical qubits to detect and recover from the errors without affecting the quantum state.

As used herein, the term “quantum gate” refers to a basic operation applied to the qubits to manipulate the associated quantum states as part of a quantum computation. Quantum gates are similar to classical logic gates but operate on quantum superposition and entanglement, enabling complex transformations of the qubit states.

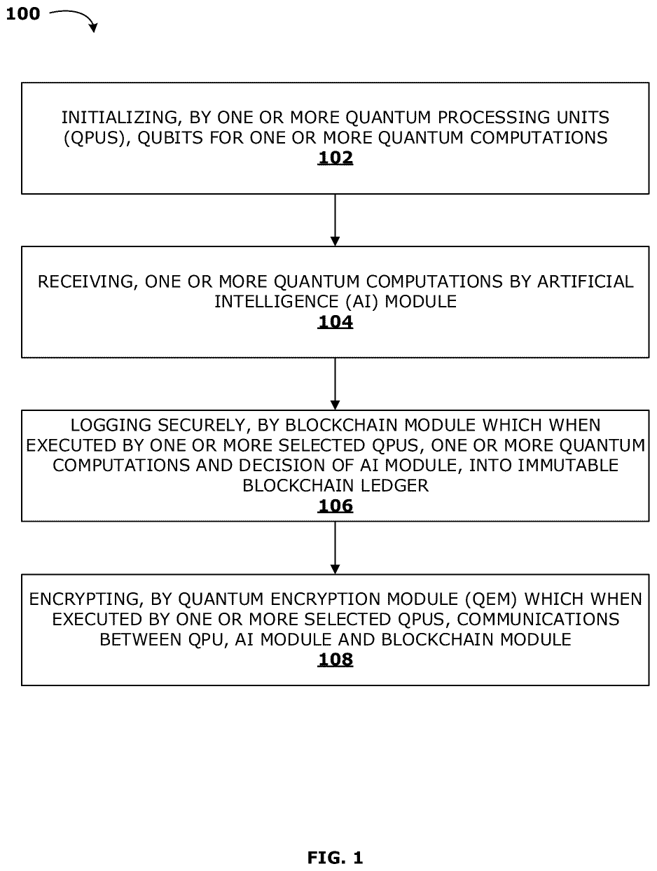

FIG. 1 illustrates a method 100 for performing one or more quantum computations, in accordance with the embodiments of the present disclosure. At step 102, the qubits are initialized by one or more quantum processing units (QPUs) (below referred as 202), wherein the quantum bit (qubit) is a basic unit of quantum information.

QPU comprises a plurality of qubits, an initialization control circuitry, and a quantum state generation hardware. The initialization control circuitry is configured to apply the control signals to the qubits to set them to the required quantum state.

Initialization of qubits by QPU refers to the process of preparing qubits, in a defined quantum state, prior to quantum computation. By initialization, the qubits start from a controlled and predictable state, 0, 1, or an arbitrary superposition or entangled state. The initialization indicates that the QPUs are ready for the quantum computations.

At step 104, the quantum computations are received by an artificial intelligence (AI) module 110. AI module 110 applies one or more machine learning techniques to analyse the received one or more quantum computations and determine the associated requirements. For an instance, requirements can be number of qubits, processing power, and time constraints. Based on the determined requirements, AI module 110 decides how to allocates resources (for example, qubits, memory, and computational capacity) and which QPU (among all QPUs) is to be selected for maximizing efficiency of computation.

At step 106, the decision made by AI module 110 (such as the allocation of quantum resources and the selection of QPUs) is logged into a blockchain module 112. Blockchain module 112 keeps a record of the decisions and quantum computations, wherein the records are tamper-proof.

At step 108, a quantum encryption module (QEM) 114 is utilized to encrypt the communication between the QPUs, AI module 110, and blockchain module 112. QEM 114 applies quantum encryption to minimize intercepting or decoding of records.

In an embodiment, AI module 110 manages the quantum resources, which are selected from qubit allocation, a quantum technique selection, and an error correction. The qubit allocation enables determination of the number of qubits required for each quantum computation and assigning the specific qubits for processing. AI module 110 utilizes machine learning techniques to analyse each quantum computation such as computation complexity and inter-qubit dependencies, to allocate qubits appropriately, thereby reducing computational overhead and conflicts between quantum operations. The quantum technique selection involves identification of suitable quantum computing techniques, based on the quantum computation. Non-limiting techniques can include variational algorithms or Grover's search techniques.

The machine learning techniques evaluate the quantum computations and selects the appropriate quantum computing techniques to optimise execution efficiency and task accuracy. The AI model 110 identifies the error-prone operations or qubits based on historical performance data or real-time feedback during computation. By using the machine learning techniques, AI module 110 is continuously updated or trained. The update or training can be performed via historical performance data or real-time feedback. By utilizing error correction techniques (such as surface codes or stabiliser codes), error rates are adjusted to enhance computational reliability.

In an embodiment, AI module 110 develops real-time models for predicting and identifying error patterns within quantum surface codes. Quantum surface codes are implemented for error correction by detecting and correcting errors in qubits. AI module 110 analyses qubit noise patterns to determine QPU-specific error rates and dynamically adjusts error correction codes based on real-time performance metrics. Targeted corrections are applied to the identified errors, addressing noise and interference that may disrupt quantum computations. Such corrections include logical qubit stabilization, gate recalibration, or the adjustment of error correction thresholds based on historical performance data.

In an embodiment, the QPUs may execute the error correction instructions provided by AI module 110, wherein the error correction instructions are dynamically updated based on analysis of the quantum computations. AI module 110 identifies the sources of errors during computation, the errors can be decoherence, gate errors, qubit relaxation, qubit rephasing, crosstalk and quantum noise. Based on the aforesaid analysis, AI module 110 generates the error correction instructions, which are executed to mitigate the errors. The error correction instructions are transmitted to the selected QPUs, which executes the error correction process concurrently with the ongoing quantum computations. Further, AI module 110 receives feedback from the QPUs, referring to the occurrence of errors and based on said feedback, the error correction instructions are dynamically updated within the QPUs. In an exemplary aspect, if QPU exhibits an error rate higher than a threshold, AI module 110 may update the stored instructions to exclude the affected QPU from critical operations and redistributes the quantum computation among the other QPUs.

In an embodiment, AI module 110 may utilize one or more machine learning techniques to predict optimal quantum gate sequences and dynamic optimization rules for the QPUs. AI module 110 may employ supervised learning techniques (such as regression models) to predict the optimum quantum gate sequences for given quantum computation. AI module 110 identifies patterns and relationships between quantum computations complexity and the required quantum gate sequences by analysing prior computational data and outcomes. For an instance, unsupervised learning techniques (such as clustering) are applied to group similar computational tasks, enabling the efficient gate sequence predictions for similar classes of problems. The reinforcement learning methods (such as Q-learning and policy gradient methods) are utilized to optimize the gate sequences during runtime (considering real-time feedback from QPUs). Ensemble techniques (such as boosting and bagging) enhance the prediction reliability by clubbing the multiple predictive models. AI module 110 may apply optimization techniques to refine gate sequence selection, so that the chosen sequences minimize computation errors and maximize the efficiency of resource. Dynamic optimization rules are derived using techniques such as neural networks, which predict adjustments needed for the runtime conditions. AI module 110 may integrate transfer learning techniques to adapt pre-trained models for previously encountered tasks, reducing computation time.

In an embodiment, quantum encryption may employ quantum entanglement and superposition for encryption and decryption of secure key. The quantum entanglement enables a secure key exchange for communication. When two or more qubits are entangled, the state of one qubit determines state of another qubit. If the entangled qubits are intruded during exchange of secure key, the quantum state is disrupted, enabling the intrusion detection. During the encryption process superposition is applied by encrypting multiple bits of information into the superimposed states of qubits, thus enhancing encryption complexity. The superposition is used to generate encryption keys which are unpredictable, making decryption without the correct key impossible. The system at receiver's end measures the superposed states to extract the encrypted information (during decryption). Quantum key distribution (QKD) applies both entanglement and superposition principles (simultaneously) to create and distribute encryption keys securely, thereby minimizing threats. QEM 114 performs dynamic adjustments to the entanglement and superposition states to adapt to varying communication needs.

In an embodiment, each QPU may operate based on a sequence of quantum gates, which manages the qubit states to execute the required quantum computations. The qubits are processed in a specific order to alter their quantum states, which is represented by the sequence of quantum gates. AI module 110 manages the execution of quantum gate sequences according to requirements of the quantum computations. AI module 110 analyses factors comprising qubit entanglement, error correction needs, and operation dependencies to generate the optimized quantum gate sequence. The QPU applies quantum gate sequence in a controlled manner by utilizing the techniques like Pauli gates, CNOT gates, and Hadamard gates, for state rotation, entanglement and superposition respectively. AI module 110 continuously monitors the quantum gate sequence, which modifies operations to minimize errors or maximize the use of resources.

In an embodiment, the dynamic reallocation of quantum resources may comprise the redistribution of qubit states within the QPUs to compensate demands of the quantum computations. Requirements of the quantum computations (comprising the number of qubits and the qubit states required to carry out the computations) are evaluated by AI module 110. Said analysis is used by AI module 110 to dynamically reallocate quantum resources among the QPUs. For instance, if a calculation requires qubits to be entangled, AI module 110 finds the QPU that has the optimum qubits and reallocates those resources to produce the required entanglement. Likewise, for superposition or any quantum rotation tasks, AI module 110 dynamically modifies the qubit states. To preserve qubit integrity during the quantum computations, redistribution may comprise moving qubits between QPUs, reinitializing qubits to a new state, or altering gate operations. To make sure that resource allocation stays in synchronization with the changing computing requirements, the process is continuously monitored. All reallocations are securely recorded by blockchain module 112, that maintains a history of resource management that can be tracked.

In an embodiment, blockchain module 112 may log the quantum technique selection and error correction adjustments made by AI module 110 onto the immutable blockchain ledger. Each time AI module 110 detects computational errors and modifies the quantum computation parameters to rectify them, blockchain module 112 logs. Said blockchain module 112 logs the kind of error that was found, the matching fix, and when those fixes were made. Quantum technique decisions such as the approach selected for task optimization or error mitigation, are also logged. All error corrections, quantum technique, new block is securely connected to the blockchain ledger by the blockchain module 112 by utilizing cryptographic hashing technique. Additionally, ID of quantum computation, the error correction technique used, and any adjustment to the resource allocation are all maintained by the blockchain module 112. To enhance transparency, said records are timestamped and distributed among multiple nodes. All logged data is encrypted by blockchain module 112, thus limiting unwanted access and preserving secure communication.

In an embodiment, AI module 110 may monitor the performance (error correction) of each QPU to adjust the allocation of quantum resources. AI module 110 calculates the error rates and correction efficiency during execution of quantum computation by analysing feedback received from the QPUs. By comparing output of the quantum computing with pre-established thresholds, analysis allows evaluation of the techniques used for error correction. Further, AI module 110 determines whether to redistribute the allotted resources (such qubits or processor cycles) based on the aforementioned analysis. The performance monitoring process involves tracking of parameters such as error frequency, repair success rate, and error resolution time. Aforesaid data are used by AI module 110 to identify QPUs that aren't operating effectively and dynamically move tasks or quantum resources to QPUs that are more efficient. To resolve persistent errors, the allocation adjustments may involve changing the task parameters or choosing different quantum techniques. By communicating said decisions to blockchain module 112 for secure logging, AI module 110 produces a verifiable log of resource reallocations and performance assessments. To provide secure communication between blockchain module 112, the QPUs, and AI module 110, the adjustments are encrypted using the QKD mechanism.

In an embodiment, blockchain module 112 may log metadata selected from the utilized quantum technique, a qubit allocation scheme, and an execution parameter associated with the quantum computations. Blockchain module 112 logs the quantum technique used to carry out the quantum computations, which may include quantum technique used, such as variational quantum eigen solvers or quantum approximate optimization techniques. Metadata related to the qubit allocation involves logging the distribution pattern of the qubits (how the available qubits were distributed among the multiple QPUs). The metadata comprises variables such as number of qubits allotted to each QPU, states of the qubits at time of allocation, and any relationships between each QPU. The metadata related to execution parameters can be selected from duration of computation, the number of quantum gates used, and any modifications made to the computational parameters throughout execution. Said metadata are kept in an immutable blockchain ledger by blockchain module 112. To secure and connect every block of metadata, the blockchain ledger cryptographic hashes, preserving the integrity of data and guarding against interception. Each block comprises a timestamp which displays the order of operations, and a unique identifier linked to the logged quantum computation.

In an embodiment, AI module 110 may optimize entanglement distribution across the QPUs to secure outcomes of quantum computations, minimize computational overhead, and maintain QKD. To determine the optimum entanglement patterns between the qubits, AI module 110 examines the quantum computation requirements. The interconnected qubits in various QPUs attain the intended quantum correlations through the selection of entanglement patterns that may compromise between security and computational efficiency as an outcome. To maintain data security, AI module 110 controls entanglement links between qubits within QPU and across plurality of QPUs. AI module 110 prohibits excessive processing demands that may result from over heading the QPUs with unnecessary entanglement operations by constantly changing the entanglement patterns. In order to maintain QKD throughout quantum computations, AI module 110 utilizes QEM 114. AI module 110 dynamically modifies the allocation technique to accommodate any changes in task requirements or resource availability while also tracking real-time feedback from QPUs to improve the entanglement distribution. QPUs communicate via the quantum channels, which employ quantum entanglement and superposition for data transmission. Data is encrypted using quantum entanglement, where the state of one qubit is directly correlated with another, ensuring secure transmission. Superposition allows the encryption process to be more resistant to attacks.

In an embodiment, AI module 110 analyses the received quantum computations and organizes them into categories based on specific parameters selected from complexity, size, resource requirements, and dependency structures. The process of categorization entails determining the features of each computation and linking them to predetermined groups. For instance, the quantum computations requiring a larger number qubit entanglement are categorized distinctly compared to those which requiring a lesser number of qubit entanglement. Said categorization helps AI module 110 to allocate resources (such as qubits, processing time, and computational capability) as efficiently as possible. AI module 110 assesses the prioritization of computations by determining which quantum computation require rapid execution and which can wait. The categorization minimizes processing time and prevents resource conflicts by managing the computation task in a specific manner. The categorization aids in determining which computation task require sequential execution because of interdependent operations or can be completed in parallel across multiple QPUs. The output of AI model 110, may adjust the quantum circuit or produce a classification or prediction.

In an embodiment, AI module 110 may be trained by reinforcement learning models utilising historical and real-time data derived from performance metrics of the one or more QPUs 202. Reinforcement learning models implement iterative optimisation processes, where historical data provides a repository for analysing long-term trends in error rates, resource allocation efficiency, and latency values. Real-time data, such as the status of current quantum computations, queue lengths, and active error correction operations, is used for adaptive decision-making. Value-function approximations and gradient-based techniques are applied to process historical and real-time data, generating dynamic policies for optimal quantum resource allocation. Said policies guide AI module 110 in selecting the QPUs 202 based on resource availability, computational accuracy, and energy efficiency. Feedback loops enable the reinforcement learning models to refine resource allocation strategies as additional performance metrics are recorded. Such training improves the adaptability of AI module 110, enabling seamless management of quantum resources in both small-scale and large-scale quantum systems. Additionally, the reinforcement learning models support scalability by evolving policies to address increasingly complex quantum computations. Exemplary federated learning frameworks such as TensorFlow Federated or PySyft can enable decentralized AI trainings across multiple QPU environments while maintaining data privacy.

In an embodiment, energy efficiency may be achieved by AI model 110 to optimise quantum resource allocation and energy usage. AI module 110 schedules low-priority quantum computations during off-peak energy demand periods, reducing the load on power-intensive QPUs 202. Techniques are developed to dynamically reallocate idle qubits to active processes or power down unused quantum components to conserve energy. Power-saving strategies include identifying idle QPUs 202 and placing them into low-power states during periods of inactivity. Real-time energy consumption metrics are analysed to optimise energy usage patterns and avoid wastage.

In an embodiment, QEM 114 may encrypt communications between the QPU 202, AI module 110, and the blockchain module 112 using lattice-based cryptography. Lattice-based cryptography mitigate vulnerabilities introduced by advancements in quantum computation. Encryption keys are generated and securely shared among the QPUs 202, AI module 110, and blockchain module 112 to protect communications. Quantum-resistant hash functions generate cryptographic hash values for transmitted data, enabling detection of unauthorised alterations. QEM 114 periodically refreshes cryptographic keys through key rotation mechanisms, reducing the risk of key compromise. Communication logs related to resource allocation and quantum computations are encrypted and stored securely in blockchain module 112. In another embodiment, hybrid encryption protocols can be developed to switch between classical and quantum-safe mechanisms based on the threat scenario.

In an embodiment, continuous-variable quantum key distribution may be applied to secure communications between the one or more QPUs 202 and QEM 114. Continuous-variable quantum key distribution encodes quantum states into continuous variables, such as amplitude and phase, enabling secure quantum key exchanges. QEM 114 manages quantum signals transmission, quantum signals are monitored to detect eavesdropping. Any interception introduces detectable anomalies, which are identified and addressed during the reconciliation phase. Privacy amplification techniques are employed to minimise the risk of information leakage. Once established, quantum keys are used by the QEM 114 to encrypt communications between the QPUs 202 and other components. The immutable blockchain module 112 records quantum key data to provide a verifiable and tamper-proof log of key exchanges. Advanced keys can be distributed by implementing continuous-variable QKD (CV-QKD) using photonic systems to ensure secure and efficient quantum key exchanges. Multiplexing techniques can be used to support multi-node key distribution in a quantum network.

In an embodiment, anomaly detection may be performed using AI model 110 trained with quantum-enhanced anomaly detection techniques. Quantum machine learning capabilities, such as superposition and entanglement identify anomalies in complex datasets. Anomalies include deviations in QPU 202 performance or irregularities in the operations of blockchain module 112. Real-time monitoring is implemented using probabilistic models, such as Bayesian inference, to predict and identify anomalies based on historical and live operational data. Quantum-enhanced anomaly detection improves the sensitivity and accuracy of identifying deviations by processing high-dimensional datasets efficiently. AI module 110 uses probabilistic methods to quantify the likelihood of anomalies and alert the system for corrective measures.

In an embodiment, the multiplexing techniques may be implemented to support secure quantum key exchanges among the one or more QPUs 202 and the blockchain module 112. Multiplexing manages simultaneous transmission of multiple quantum keys over shared communication channels, thereby improving the efficiency of key distribution. Techniques such as wavelength-division multiplexing and time-division multiplexing are employed to separate quantum key exchanges by assigning unique wavelengths or time slots to each key. Such methods prevent interference and maintain the integrity of the quantum keys during transmission. The blockchain module 112 records multiplexed quantum key exchanges to establish an immutable record for future validation. The multiplexing techniques are used by the AI module 110 to dynamically allocate communication resources, minimise latency and optimise channel utilisation.

In an embodiment, the one or more QPUs 202 may employ quantum annealing to reconfigure qubits upon detection of faults during initialisation or execution of the quantum computations. Quantum annealing utilizes quantum fluctuations to guide qubits towards a ground state that represents the solution to computational problems. Upon detecting faults, the QPUs 202 dynamically adjust the quantum states of qubits to maintain computational accuracy without interrupting ongoing processes. Such reconfiguration mechanisms enhance the reliability of quantum computations by minimising disruptions caused by qubit errors. Fault detection mechanisms integrated into the QPUs 202 identify anomalies in qubit behaviour, triggering reconfiguration processes through quantum annealing.

In an embodiment, the system 100 may utilize machine learning models to predict potential hardware failures in the QPUs 202 and initiate preemptive measures to mitigate disruptions. Said machine learning models process historical and real-time performance data, including qubit error rates, temperature fluctuations, latency variations, and power consumption metrics, to identify patterns indicative of impending malfunctions. By analysing such data, predictions are generated regarding the likelihood and location of hardware failures. Upon detecting a potential failure, computational tasks are dynamically rerouted to alternate quantum processing units 202 to maintain uninterrupted operations. Additionally, preemptive repairs are triggered for the identified faulty components, ensuring timely resolution of hardware issues.

In an embodiment, initialisation of the qubits by the one or more QPUs 202 may comprise generating quantum digital signatures for each qubit. Quantum digital signatures provide a unique identifier for qubits, enabling authentication and verification processes. QEM 114 verifies the authenticity of the quantum digital signatures using quantum-based verification methods. Such quantum digital signatures are securely stored in the immutable blockchain module 112, creating a reliable record of qubit initialisation states. Storing quantum digital signatures in the blockchain module 112 facilitates future authentication processes and assures the integrity of quantum resources. Authentication can be enhanced by quantum-based protocols using quantum digital signatures for verifying users. Quantum fingerprinting ensures that no two authentication keys are identical, enhancing security.

In an embodiment, the blockchain module 112 may be upgraded to use hash-based cryptographic signatures, such as Lamport or XMSS, for securing transactions. Hash-based cryptographic signatures utilize the computational difficulty of pre-image resistance in hashing functions, providing resistance against attacks from quantum computing systems. Such signatures are integrated into transaction verification processes to authenticate and validate recorded data. The blockchain module 112 employs quantum random number generation (QRNG) to produce random numbers for consensus operations. Quantum random number generation is based on inherent quantum mechanical processes, generating numbers with true randomness to enhance the security and unpredictability of block validation. Quantum consensus mechanisms based on QRNG provide secure and efficient methods for reaching agreement among nodes during the addition of blocks to the blockchain module 112. The blockchain module 112 records all quantum computations, resource allocations, and transaction data securely in an immutable ledger, ensuring the traceability of all operations across the quantum computing system. The integration of hash-based cryptographic signatures and quantum consensus mechanisms strengthens the security and scalability of blockchain module 112 while mitigating vulnerabilities associated with quantum computing.

In an embodiment, the one or more QPUs 202 may perform a quantum state tomography to reconstruct and verify the quantum state after computation. Quantum state tomography involves analysing measurement outcomes to derive a mathematical representation of the quantum state. Automation of the reconstruction and verification process is achieved by embedding quantum state tomography into the AI module 110.

In an embodiment, QPU 202 may achieve standardisation and interoperability through the adoption of quantum programming frameworks such as Quantum Assembly Language (OpenQASM) and Quantum Intermediate Representation (QIR). OpenQASM provides a universal quantum assembly language, enabling compatibility across different QPU 202 architectures. Quantum Intermediate Representation acts as a standardised intermediate format for quantum program compilation, supporting the integration of diverse hardware platforms. The AI module 110 uses quantum software platforms, such as Qiskit and Cirq, to develop quantum programs for seamless execution across heterogeneous systems. Interoperability is achieved by translating quantum instructions into formats compatible with different hardware configurations. Standardisation supports the collaborative development and deployment of quantum solutions.

In an embodiment, the system 100 may utilize a hybrid quantum-classical computing to optimise computational processes by dividing tasks between QPUs 202 and classical processors. Classical processors simulate quantum algorithms to test feasibility and accuracy before execution on quantum hardware. A quantum-classical interface application programming interface (API) is developed to facilitate seamless communication between quantum and classical systems. Computation tasks are divided based on resource requirements and algorithm complexity. Tasks requiring non-linear problem-solving are assigned to quantum systems, while tasks with deterministic processing requirements are executed by classical processors.

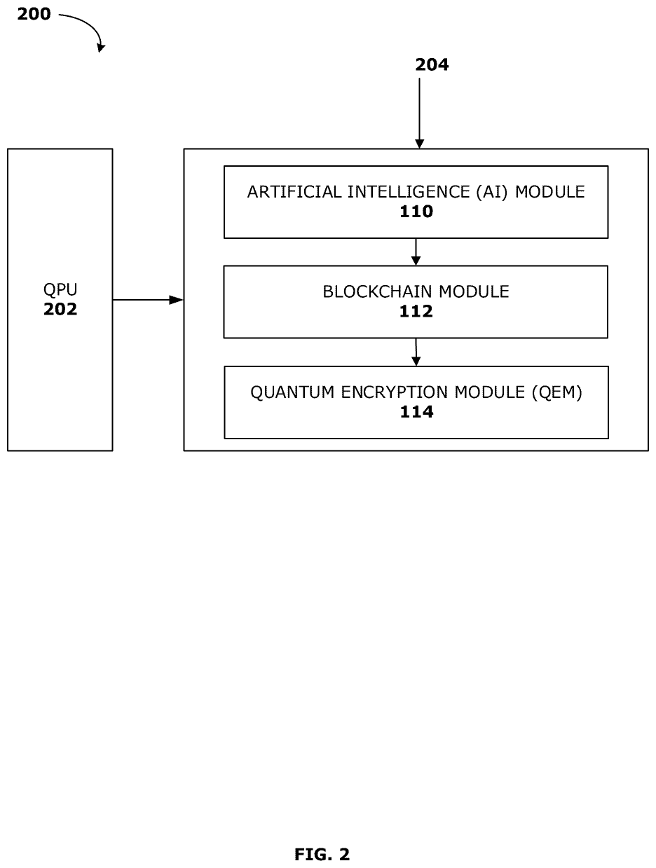

FIG. 2 illustrates a quantum computing system 200, in accordance with the embodiments of the present disclosure. The quantum computing system 200 comprises one or more quantum processing units (QPUs) 202, a non-transitory storage device 204 and other known components of quantum computing device/apparatus. It can be appreciated that the aforementioned components of system 200 are communicably coupled with each other.

In an embodiment, the QPUs 202 (interchangeably referred as QPU 202) are the computational entity of the quantum computing system 200. The QPU 202 initiates operation by initialization of qubits, which are the fundamental units of quantum information. Initialization enables setting up the qubits in specific states required for the quantum computations. The specific states can be selected from superposition or entanglement. A qubit can be represented as 0 and 1 (or both) at the same time in a superposition situation. In contrast, entanglement occurs when two or more qubits are connected in a way that affects the states of the others.

In an embodiment, each QPU 202 is communicably coupled to non-transitory storage device 204. Unlike volatile memory, which loses data when powered off, non-transitory storage device retains data persistently. Non-transitory storage device 204 can be a flash drive, a RAM, a cloud storage or other known data storage devices. Non-transitory storage device 204 comprises AI module 110, blockchain module 112, and QEM 114.

In an embodiment, AI module 110 is arranged to manage and optimize the quantum computations. AI module 110 receives the quantum computations (upon initialization of the qubits), wherein AI module 110 utilizes a machine learning technique (selected from an artificial neural network (ANN), a convolutional neural network (CNN), a Hybrid Markov Model (HMM), AI, a deep learning, etc.) to analyse the received quantum computations to assess a complexity, a resource requirement, and the execution constraints. Estimating the required processing power, number of qubits, and any time limits are essentially included in the analysis. In an exemplary aspect, a quantum computation involving basic data encryption, for instance, might be estimated by AI module 110 to require three qubits, a minimum processing power of twenty quantum gates, and to be completed in one millisecond for safe real-time communication.

In an embodiment, AI module 110 distributes quantum resources to the optimum QPUs 202. For the received quantum computations to be executed effectively, AI module 110 evaluates the workload and capability of the available QPUs 202. AI module 110 assigns qubits and divides computational workloads while maximizing resource consumption to prevent bottlenecks or redundant procedures. Throughout the process, AI module 110 monitors feedback, manages resource allocation and computational strategies as needed to adapt to changing quantum computation parameters and mitigate errors. AI module 110 may utilize quantum circuits, making real-time decisions on large data sets while also predicting, optimizing, and adjusting parameters simultaneously.

In an embodiment, blockchain module 112 enhances immutability in the quantum computations. Blockchain module 112 logs information such as the received quantum computations, the decisions made by AI module 110 for resource allocation, and the one or more QPUs 202 selected to execute the received quantum computations. Upon execution, blockchain module 112 creates an immutable ledger that records each step of the execution of quantum computations in a tamper-proof manner. Blockchain module 112 may utilize a cryptographic hashing technique to secure every entry, wherein the cryptographic hashing technique assures that any modifications to the logged data are immediately detectable.

In an embodiment, blockchain module 112 generates a block for each decision (such as the allocation of quantum resources and selection of QPUs 202) made by AI module 110. Each generated block comprises data such as a unique code for the quantum computation, resource usage details and a time information.

Said blockchain module 112 is configured to enable decentralized verification of quantum computations, ensuring the immutability and transparency of data transactions. Attempts to alter data or manipulate results are detected and rejected by the consensus mechanism of said blockchain module 112. Said module 112 further provides a cryptographically secure audit trail for operations, facilitating monitoring, accountability, and resistance to single points of failure or quantum-based attacks.

Said blockchain module 112 enabled smart contracts are configured to autonomously execute multi-party agreements based on predefined AI module 110 conditions, making sure provable fairness and transparency. Applications include healthcare, finance, and supply chain management, where trust and data integrity are critical. Said system ensures encrypted communication between QPUs 202, AI module 110, and blockchain module 112 via said QEM 114, further enhancing data security and reliability.

In an embodiment, smart contracts automate the allocation and scheduling of quantum resources among multiple users. Distributed ledgers are used to record resource usage metrics, providing transparency in resource allocation. Quantum resource distribution is enforced through rules encoded in the smart contracts, enabling fair access to QPUs 202 and other system components. Usage metrics are analysed to optimise resource sharing policies, supporting scalability as additional users or resources are incorporated into the system.

In a further embodiment, the QEM 114 is arranged to establish secure communications within the quantum computing system 200. QEM 114 generates safe encryption keys (utilizing a quantum key distribution (QKD) that are difficult to intercept or secretly decipher. Using the produced safe encryption keys, QEM 114 encrypts data flow between the QPUs 202, AI module 110, and blockchain module 112. During transfer, the encryption stops unwanted access to data (such job specifics, resource allocation choices, and calculation outcomes). The safe encryption keys' integrity is regularly checked by QEM 114, which can also regenerate them. QEM 114 is resistant to both classical and quantum attacks, providing robust security for data both within the system and during external communications. In order to confirm that all logged data (such computation records and decisions) is encrypted prior to being stored in blockchain module 112, QEM 114 communicates with blockchain module 112. All communication among AI module 110, QPUs 202, and blockchain module 112 is encrypted with quantum-secured keys. If any tampering or interception attempt is detected, an alert is raised, and communication can be halted or redirected. Additionally, the system continuously monitors encrypted channels for tampering. If tampering is detected, the quantum state disturbance triggers a security protocol, including alerting nodes and reissuing quantum keys.

In an exemplary aspect, an organization needs to optimize route planning for a fleet of delivery vehicles operating in an urban setting with typical traffic conditions. The quantum computing system initializes qubits within QPUs 202 to prepare quantum states such as superposition and entanglement, thereby enabling simultaneous evaluation of multiple route combinations. The routing problem, encoded as a quantum computation task, is received by the AI module 110, which processes data including vehicle locations, delivery destinations, traffic patterns, and time constraints. The AI module 110 analyses the problem using machine learning techniques to identify task dependencies, predict resource allocation, and allocate qubits for representing intersections, travel times, and delivery priorities. AI module 110 prioritizes high-impact computations by selecting optimum quantum processing units and dynamically manages quantum resources selected from the qubits and quantum gates, based on analysis. Blockchain module 112 prepares a tamper-proof record of task execution and resource allocation, wherein blockchain module 112 securely logs the quantum computations and decisions made by the AI module 110 onto an unchangeable blockchain ledger during execution. Through the use of quantum key distribution, the QEM 114 encrypts communications between the blockchain, AI, and QPUs 202 while preserving data integrity and secrecy. The quantum computations generate optimized routing solutions in real time, accounting for complex variables such as traffic patterns and delivery schedules, enabling efficient route planning for the entire fleet.

In an embodiment, the quantum resources may comprise a qubit allocation, a quantum technique selection, and an error correction, wherein the qubit allocation comprises assigning a specific number of qubits within QPU 202 to perform the quantum computations based on qubit interdependencies and task complexity. Quantum technique selection comprises selecting the optimum computational techniques (such as Grover's algorithm or Shor's algorithm, based on the requirements of computation) for QPU 202. Error correction resolves quantum decoherence and operational inaccuracies, enhancing accurate results. The error correction codes like surface codes or concatenated codes can be implemented, wherein parameters related to said code is managed by non-transitory storage device 204.

In an embodiment, AI module 110 may identify, the optimal quantum gate sequences and the dynamic optimization rules for QPU 202 by applying one or more machine learning techniques. By analysing the computational requirements stored in non-transitory storage device 204, AI module 110 identifies optimum quantum gate sequences. To implement the optimization rules, machine learning techniques (such deep learning or reinforcement learning) may adapt to the operational data of system. The optimization rules may then be dynamically modified in response to the feedback from QPU 202.

In an embodiment, the quantum encryption may employ quantum entanglement and superposition for encryption and decryption through QEM 114. The QPU 202 uses quantum entanglement to link qubit pairs and makes sure that their states are connected. Superposition allows each qubit to be in multiple encryption states at the same time. QEM 114 utilizes unique combinations of entangled and superposed states to generate secure quantum keys. Entangled qubits are measured during decryption to make sure that any intrusion can be identified by changes in quantum states.

In an embodiment, AI module 110 may dynamically reallocate the quantum resources by redistributing qubit states of QPU 202 based on the computational requirements. Through real-time feedback from the QPU 202, AI module 110 may reassign qubits that are overburdened or underutilized. The redistribution enables optimal balancing of workload throughout QPU 202. Qubit state transitions are carried out without interrupting with running computations, and activities are prioritized according to qubit fidelity and urgency using rules stored in non-transitory storage device 204. AI module 110 adapts in real-time, thereby ensuring efficient use of quantum resources and improving computational speed while reducing power consumption.

In an embodiment, blockchain module 112 may record error correction adjustments and quantum technique selections (performed by AI module 110) onto an immutable blockchain ledger. Each block in the immutable blockchain ledger is cryptographically connected and comprises extensive information about the selected quantum techniques and the error correction techniques utilized with QPU 202. To preserve a tamper free log of the computations carried out by QPU 202, said logs are securely stored within non-transitory storage device 204. Said blockchain module 112 is amplifies security, ensuring data integrity, transparency, and immutability. Each quantum computation task and data transaction are logged on a decentralized blockchain ledger, allowing for verifiable and tamper-proof operations.

In an embodiment, AI module 110 may monitor error correction performance of each QPU 202 to adjust allocation of the quantum resources. The data stored within non-transitory storage device 204 are utilized by AI module 110 to assess the error correction performance metrics that comprises parameters such as error rates, qubit coherence times, etc. Based on the assessment, AI module 110 initiates dynamic resource reallocation, thereby prioritizing tasks for QPUs 202 with better error correction capabilities and lowers resource allocation for the QPUs 202 with greater error rates.

In an embodiment, non-transitory computer-readable storage medium comprises a set of instructions which, when executed by the quantum processing units (QPUs) 202, causes the QPUs 202 to perform a method for quantum computations. The method comprises initializing qubits to prepare quantum states (such as superposition or entanglement), enabling the QPUs 202 to execute quantum computations with improved accuracy. The instructions further comprise receiving quantum computations by AI module 110, which analyses the computations using machine learning techniques to dynamically allocate and optimize quantum resources, such as a qubit allocation, a quantum technique selection, and an error correction. Based on the analysis, AI module 110 selects one or more QPUs to execute the computations. The selected QPUs 202 securely logs quantum computations and resource allocation decisions into an immutable blockchain ledger using a blockchain module, thereby creating a tamper-proof record of the processes. The instructions also comprise encrypting (by applying a quantum key distribution (QKD)) the communication between the QPUs 202, AI module 110, and blockchain module 112 by utilizing QEM 114, enabling secure communication throughout the quantum computing process.

In an embodiment, the method begins by initializing qubits within QPUs 202 to prepare quantum states (such as superposition or entanglement), which enables the execution of quantum computations with reduced errors rate and enhanced fidelity. AI module 110 receives quantum computations, whereby AI module 110 uses machine learning techniques to analyse task requirements and dynamically allocate quantum resources, such as qubit allocation, quantum technique selection, and error correction strategies. Blockchain module 112 utilizes immutable ledger to securely record the quantum computations and the resource allocation choices. Utilizing a QEM 114, communication between the QPUs 202, AI module 110, and blockchain module 112 is encrypted. The encryption protects data exchanges from interruptions and unauthorized access while maintaining integrity of computational processes.

The disclosed system 200 integrating quantum computing, AI, and blockchain, with applications spanning finance, healthcare, and Internet of Things (IoT) systems. Said system 200 utilizes quantum-enhanced predictive models and quantum-boosted neural networks to address industry-specific challenges, ensuring secure, efficient, and scalable operations.

In the financial industry, said system 200 enables secure trading, advanced fraud detection, and improved risk management through quantum-enhanced AI models capable of processing large datasets. Quantum encryption secures transactions, while blockchain technology ensures trust and accountability in distributed trading platforms. Quantum optimization facilitate forecasting of stock market trends with increased accuracy.

For more understanding, as an example in domain of finance industry, one or more quantum processing units (QPUs) 202 configured to initialize qubits for performing quantum computations related to financial operations, including risk analysis, portfolio optimization, and fraud detection.

Said AI module 110 receives financial computations and utilizes machine learning techniques to analyse such computations. Dynamic allocation and optimization of quantum resources are performed by said AI module 110 to select appropriate QPUs 202 for tasks such as real-time data analysis and prediction modelling based on financial data set. Said blockchain module 112, when executed by said selected QPUs 202, securely records financial transactions, risk assessments, and resource allocation decisions into an immutable blockchain ledger, ensuring traceability and regulatory compliance.

Said QEM 114 utilizes quantum key distribution (QKD) to generate quantum keys for encrypting communications among the QPU 202, the AI module 110, and the blockchain module 112. Encryption manages secure handling of financial data, such as client information, transaction records, and financial models. The quantum computing system 100 enhances efficiency, accuracy, and security in financial operations by utilizing quantum computing, AI, and blockchain.

In decentralized healthcare, said system integrates AI-powered diagnostic tools on quantum chips to deliver real-time, precise recommendations. Blockchain ensures secure, authorized sharing of patient data, while quantum encryption protects sensitive records from cyber threats.

In secure Internet-of-Things (IoT) systems, quantum chips combined with AI, blockchain, and quantum encryption provide a robust framework for real-time decision-making and decentralized management of IoT networks. Such integration ensures scalable and secure communication across large device ecosystems.

As another exemplary scenario of IoT networks, QPUs 202 can initialize and process IoT devices data for executing distributed QPU 202 related quantum computations. Each QPU 202 is operatively coupled to a non-transitory storage device 204, the storage device 204 embedding AI module 112, blockchain module 114, and QEM 114. The AI module 110 is configured to process data streams generated by IoT sensors and actuators and employs machine learning techniques to analyse such streams for dynamically managing the allocation and optimization of computational resources among the QPUs 202. Blockchain module 112, when executed by the selected QPUs 202, records sensor data, task execution logs, and AI-generated optimization decisions into an immutable blockchain ledger, thereby data security across the IoT networks. QEM 114 employs encrypted communication between the QPU 202, AI module 110, and blockchain module 112. The system 100 further facilitates secure edge-to-cloud communication, therefore compliance with data integrity protocols, and real-time decision-making capabilities.

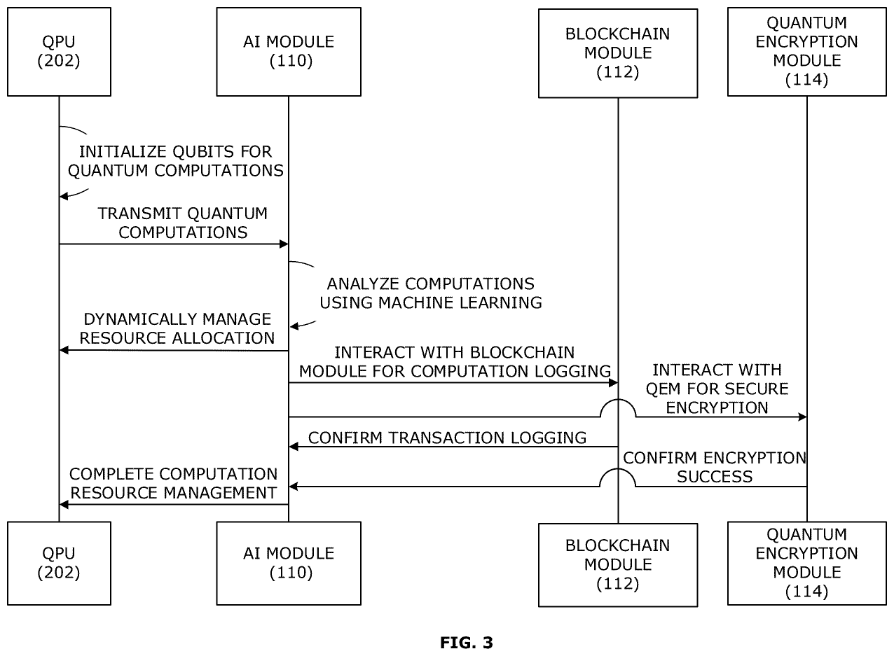

FIG. 3 illustrates a sequence diagram for a quantum computing system, depicting the interaction between components in accordance with the embodiments of the present disclosure. The QPU 202 initializes qubits to initiate for quantum computations. Following initialization, an AI module 110 receives quantum computations and utilizes machine learning techniques to assess the computations and dynamically manage quantum resources (such as selecting a quantum technique and allocating qubits). The AI module 110 securely logs computations and resource allocation decisions into an immutable blockchain ledger, creating an unchangeable record, and relays these decisions back to the quantum processor unit. Using quantum key distribution, AI module 110 also uses the quantum encryption technique to encrypt communications between blockchain module 112, quantum processor unit, and AI module 110. The sequence ends with confirmations of successful transaction logging and encryption, followed by the QPU 202 completing the resource management and computational tasks.

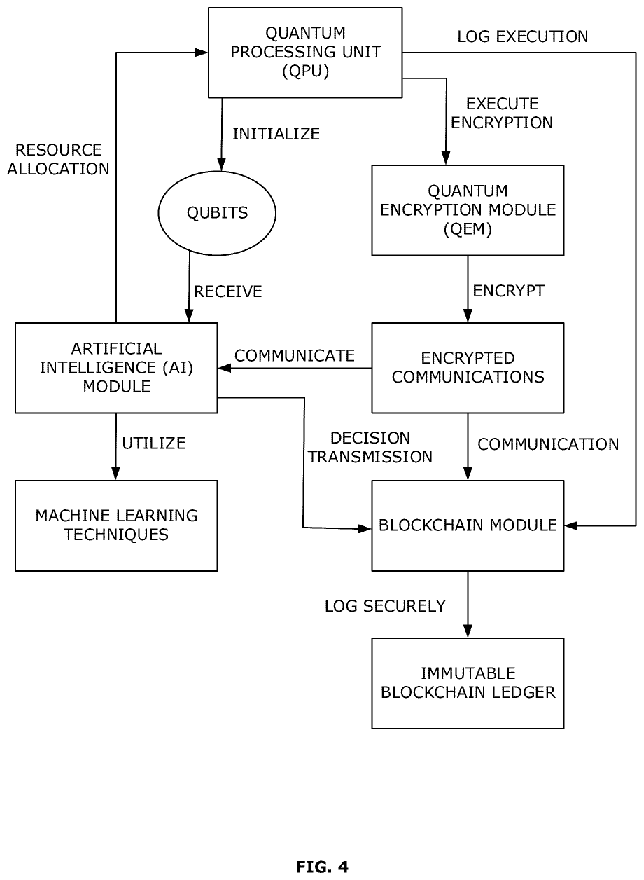

FIG. 4 illustrates representation for performing quantum computation, in accordance with the embodiments of the present disclosure.

QPU 202 is configured to initialize qubits for quantum computations. The initialized qubits are subsequently received by AI module 110, which is further configured to utilize machine learning techniques. Said machine learning techniques are employed to analyse quantum computations for dynamically managing allocation and optimization of quantum resources, which are used for selecting QPUs 202.

AI module 110 communicates with a blockchain module 112, and decisions from AI module 110 are securely logged into an Immutable Blockchain Ledger by such blockchain module 112. The logging process is executed by said QPU 202 in collaboration with blockchain module 112.

QEM 114 is operatively connected to the QPU 202. Said QEM is utilized to execute encryption processes, specifically through encrypting communications among the QPU 202, AI module 110, and blockchain module 112. Encrypted communications are stored in a separate entity denoted as Encrypted Communications, which also facilitates communication between AI module 110 and blockchain module 112.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general-purpose computer, special purpose computer, or other programmable data processing apparatus to produce a machine, such that the instructions which execute on the computer or other programmable data processing apparatus create means for implementing the functions specified in the flowchart block or blocks.

The term “non-transitory storage device” or “storage” or “memory,” as used herein relates to a random-access memory, read only memory and variants thereof, in which a computer can store data or software for any duration.

Operations in accordance with a variety of aspects of the disclosure is described above would not have to be performed in the precise order described. Rather, various steps can be handled in reverse order or simultaneously or not at all.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings are used. Those skilled in art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method for performing the one or more quantum computations, the method comprising:
initializing, by the one or more quantum processing units (QPUs), the qubits for the one or more quantum computations;
receiving, the one or more quantum computations by an artificial intelligence (AI) module, wherein the AI module utilizes one or more machine learning techniques to analyze the received one or more quantum computations to dynamically manage allocation and optimization of the one or more quantum resources for selection of one or more QPUs;
logging securely, by a blockchain module which when executed by the one or more selected QPUs, the one or more quantum computations and decision of the AI module, into an immutable blockchain ledger; and
encrypting, by a quantum encryption module (QEM) which when executed by the one or more selected QPUs, the communications between the QPU, the AI module and the blockchain module.

2. The method of claim 1, wherein the quantum resources comprising a qubit allocation, a quantum technique selection and an error correction.

3. The method of claim 1, wherein the QPUs execute the error correction instructions provided by the AI module, wherein the error correction instructions being dynamically updated based on analysis of the one or more quantum computations.

4. The method of claim 1, wherein the AI module utilizes one or more machine learning techniques to predict the optimal quantum gate sequences and the dynamic optimization rules for the QPUs.

5. The method of claim 1 wherein the quantum encryption employs quantum entanglement and superposition for encryption and decryption.

6. The method of claim 1, wherein each QPU is associated with a sequence of quantum gates being controlled by the AI module to perform the one or more quantum computations.

7. The method of claim 1, wherein the dynamic reallocation of the quantum resources by the AI module comprises redistribution of the qubit states of the QPUs, based on the one or more quantum computations.

8. The method of claim 1, wherein the blockchain module records the error correction adjustments and the quantum technique selection performed by the AI module, onto the immutable blockchain ledger.

9. The method of claim 1, wherein the AI module monitors an error correction performance of each QPU to adjust the allocation of quantum resources.

10. The method of claim 1, wherein the blockchain module logs metadata selected from a utilized quantum technique, a qubit allocation scheme, and an execution parameter associated with the one or more quantum computations.

11. The method of claim 1, wherein the AI module optimizes entanglement distribution across the QPUs to secure the one or more quantum computations outcomes to minimize a computational overhead and maintain QKD.

12. The method of claim 1, wherein the AI module categorizes received one or more quantum computations and allocates the qubits across the plurality of QPUs based on the categorization.

13. The method of claim 1, wherein the AI module is trained by the reinforcement learning models utilizing historical and real-time data derived from the performance metrics of the one or more QPUs to improve accuracy and efficiency for allocation and optimization of the quantum resources.

14. The method of claim 1, wherein encryption of the communications between the QPU, the AI module, and the blockchain module is performed by lattice-based cryptography and the quantum-resistant hash functions.

15. The method of claim 1, the multiplexing techniques support the secure quantum key exchanges among the QPUs and the blockchain module.

16. A quantum computing system, the system comprising:
the one or more quantum processing units (QPUs) initializes the qubits for one or more quantum computations, each QPU is coupled to a non-transitory storage device, wherein the non-transitory storage device comprises an artificial intelligence (AI) module, a blockchain module and a quantum encryption module (QEM);
the AI module:
receives the one or more quantum computations; and
utilizes one or more machine learning techniques to analyze the received one or more quantum computations to dynamically manage allocation and optimization of the one or more quantum resources for the one or more QPUs selection;
the blockchain module, which when executed by the one or more selected QPUs, securely logs the one or more quantum computations and decision of the AI module, into an immutable blockchain ledger; and
the quantum encryption module (QEM), which when executed by the one or more selected QPUs, utilizes quantum key distribution (QKD) to generate the quantum keys to encrypt the communications between the QPU, the AI module and the blockchain module.

17. The quantum computing system of claim 16, wherein the quantum resources comprising a qubit allocation, a quantum technique selection and an error correction.

18. The quantum computing system of claim 16, wherein the AI module utilizes one or more machine learning techniques to predict the optimal quantum gate sequences and the dynamic optimization rules for the QPUs.

19. The quantum computing system of claim 16, wherein the quantum encryption employs quantum entanglement and superposition for encryption and decryption.

20. The quantum computing system of claim 16, wherein the dynamic reallocation of the quantum resources by the AI module comprises redistribution of the qubit states of the QPUs, based on the one or more quantum computations.

21. The quantum computing system of claim 16, wherein the blockchain module records the error correction adjustments and the quantum technique selection performed by the AI module, onto the immutable blockchain ledger.

22. The quantum computing system of claim 16, wherein the AI module monitors an error correction performance of each QPU to adjust the allocation of quantum resources.

23. A non-transitory computer-readable storage medium embodying a set of instructions, which when executed by one or more quantum processing units (QPUs), causes the one or more QPUs to perform a method comprising:
initializing, the qubits for the one or more quantum computations;
receiving, the one or more quantum computations by an artificial intelligence (AI) module, wherein the AI module utilizes one or more machine learning techniques to analyze the received one or more quantum computations to dynamically manage allocation and optimization of the one or more quantum resources for selection of one or more QPUs;
utilizing the one or more selected QPUs for:
logging securely, the one or more quantum computations and decision of the AI module, into an immutable blockchain ledger; and
encrypting, the communications between the QPU, the AI module and the blockchain module.
